(19) United States
(12) Patent Application Publication
(10) Pub. No.: US 2025/0312813 A1
(43) Pub. Date: Oct. 9, 2025

(54) METHOD FOR COATING A WORKPIECE, COATING DEVICE, AND COMPUTER PROGRAM FOR SETTING UP A COATING DEVICE

(71) Applicant: HOMAG GmbH, Schopfloch (DE)

(72) Inventors: Patrick MÜLLER, Glatten (DE); Max HARTMANN, Ammerbuch (DE); Daniel SEID, Tübingen (DE); Lars WEIMER, Simmersfeld (DE)

(21) Appl. No.: 18/577,648

(22) PCT Filed: Jul. 7, 2022
(86) PCT No.: PCT/EP2022/068855

§ 371 Date: Jul. 8, 2024

(30) Foreign Application Priority Data
Jul. 9, 2021 (DE) 10 2021 117 813.4

(51) Int. Cl. B05C 11/10

(52) U.S. Cl. CPC B05C 11/10

(57) ABSTRACT

The invention relates to a method for coating a workpiece (11), wherein a coating material (12) is adhered to a surface of the workpiece (11) by means of an adhesive layer (13), having the steps: defining a model for optimizing at least one target variable, in which the adjustment of at least one control variable in dependence on a plurality of disturbance variables is mapped, determining a plurality of disturbance variables which influence the coating operation, and adjusting at least one control variable by means of the model and on the basis of the determined disturbance variables, and to a coating device (10) for coating a workpiece (11), and to a computer program for setting up a coating device (10).

### TECHNICAL FIELD

The invention relates to a method for coating a workpiece, to a coating device for coating a workpiece, and to a computer program for setting up a coating device.

### PRIOR ART

Coating devices are known by means of which workpieces can be coated with a coating material, for example a narrow side of a workpiece in board form can be coated with an edge material. Owing to a constantly increasing diversity and a high breadth of variation of the material properties of the materials to be processed, in particular workpieces, edge material and/or adhesives, a machine operator requires extensive experience in order to correspondingly adapt parameters of the coating device in dependence on the materials used, so that a quality result of uniformly high quality can be achieved by the coating operation.

### DESCRIPTION OF THE INVENTION

The object of the invention is to propose a method for coating a workpiece by means of which a uniform coating quality is achieved. An additional object of the invention is to propose a coating device by means of which a uniform coating quality and a high degree of automation in the coating of workpieces is achieved. A further object of the invention is to propose a computer program by means of which a high degree of automation of a coating device is made possible.

A method for coating a workpiece is defined in claim 1. A coating device for coating a workpiece is defined in claim 12. A computer program for setting up a coating device is claimed in claim 13. Dependent claims relate to specific embodiments.

This object is achieved by a method for coating a workpiece, which preferably consists at least in part of wood, wood-based materials, plastics material or the like, in which a coating material is adhered to a surface of the workpiece by means of an adhesive layer. In this method, a model for optimizing at least one target variable is defined, in which the adjustment of at least one control variable in dependence on a plurality of disturbance variables is mapped. Furthermore, a plurality of disturbance variables which influence the coating operation is determined, and at least one control variable is adjusted by means of the model and on the basis of the determined disturbance variables.

By adjusting the at least one control variable in dependence on the determined disturbance variables by means of the model, the at least one target variable for a corresponding coating operation can be optimized. The at least one target variable can represent a measure of a quality result of the coating operation, which can be determined by the at least one target variable. The at least one target variable can be defined by a desired value range. A quality result of the coating operation can thus be increased significantly by the model for optimizing the at least one target variable.

A preferred embodiment of the method can provide that the at least one target variable is selected from a pull-off strength of the coating material from the workpiece, a tightness of the adhesive layer between the coating material and the workpiece, a layer thickness of the adhesive layer, a thermal stability of the adhesive layer, a shrink hole condition of the adhesive layer, a water vapor resistance of the adhesive layer and/or of the coating material, and/or a resistance of the adhesive layer and/or of the coating material to immersion in water.

The at least one target variable can be defined on the basis of one or more of these parameters. It is thus possible to quantify the quality result, so that a quality result achieved by the coating operation can be acquired, controlled, regulated and/or monitored on the basis of the at least one target variable.

In a further development of the method, it can be provided that the at least one target variable is determined by at least partially destroying at least one workpiece coated with the coating material.

By at least partially destroying the coated workpiece, in particular the pull-off strength of the coating material from the workpiece, which is also referred to as the peel resistance, can be determined. The at least one target variable can be determined both manually and in an automated manner, for example by suitable acquisition devices, measuring devices and/or sensors. The at least one target variable can be determined during the coating operation. The at least one target variable can be determined both at periodic intervals on specific workpieces and at variable intervals.

Advantageously, it can be provided in the method that the results of the at least one selected target variable are used to define the model for optimizing at least one target variable.

In this manner, a method which independently defines and/or optimizes itself can be achieved. The model is defined and/or adapted on the basis of results of the at least one selected target variable from at least one already coated workpiece, in order to optimize at least one target variable for at least one workpiece which is subsequently to be coated.

In one embodiment of the method, at least one disturbance variable can be determined from at least one defined parameter of the workpiece, of the coating material, of the adhesive, of an environment, of a processing tool and/or of a coating device, for example at least one processing tool of the coating device. Disturbance variables of a coating device can be selected, by way of example and not exhaustively, from: the type of coating device, one or more defined machine parameters, a degree of wear of one or more processing tools, a condition of the processing unit, an imbalance of the tool, a combination thereof.

The at least one disturbance variable can form an unchangeable parameter. Preferably, the at least one disturbance variable can be at least one material property of the workpiece, in particular of a narrow side of the workpiece, of the coating material and/or of the adhesive. Particularly preferably, the at least one disturbance variable can be a physical and/or chemical property of the workpiece, in particular of a narrow side of the workpiece, of the coating material and/or of the adhesive. A parameter of the environment can be, for example, an ambient temperature, ambient humidity, ambient light intensity or the like. A parameter of the at least one processing tool can be, for example, a degree of wear, defect or the like. The at least one disturbance variable can be acquired by suitable acquisition devices, measuring devices and/or sensors and/or can be defined as a known parameter, for example by material specifications of the manufacturer.

Particularly preferably, it can be provided in the method that the at least one control variable is selected from at least one changeable parameter of the workpiece, of the coating material, of the adhesive, of the environment and/or of the coating device.

Preferably, the at least one control variable can be a changeable property of the workpiece, in particular of a narrow side of the workpiece, of the coating material and/or of the adhesive. Changeable parameters of the coating device can in particular form adjustment parameters of the coating device or of components of the coating device for the coating operation.

In addition, it can preferably be provided in the method that the at least one control variable is monitored and used to define the model for optimizing at least one target variable, and is preferably selected from a pressing force of a pressing device, a contact temperature of the pressing device, a temperature, preferably contact temperature, of the adhesive on an application device, a temperature of the workpiece, coating material and/or adhesive prior to adhesion to the surface of a workpiece, and/or the layer thickness of the adhesive layer.

Preferably, the coating method can be monitored on the basis of individual selected control variables. These selected control variables can be significant control variables which are influenced by further or subordinate control variables and/or disturbance variables. In this manner, the further or subordinate control variables and/or disturbance variables of the coating operation can be validated by means of the monitoring of only individual selected control variables.

In an advantageous further development of the method, the model can be defined by means of the plurality of disturbance variables, the at least one control variable and/or the at least one target variable, achieved thereby, of at least one workpiece coated by the coating operation, in order to optimize at least one target variable for at least one further workpiece to be coated.

In this manner, the model can be defined by means of the acquired disturbance variables, at least one control variable and/or at least one target variable of one or more coated workpieces and on the basis thereof at least one target variable for at least one workpiece to be coated can be optimized.

A particularly preferred embodiment of the method can provide that the model is defined dynamically by an optimization algorithm by means of the plurality of disturbance variables, the at least one control variable and/or the at least one target variable, achieved thereby, of a large number of workpieces coated by the coating operation.

By means of the optimization algorithm, the model can be adapted and optimized in dependence on the plurality of disturbance variables, the at least one control variable and/or the at least one target variable on the basis of a large number of coated workpieces. With an increasing number of coated workpieces, that is to say with an increasing data set of disturbance variables, control variables and/or target variables of coated workpieces, an improvement in the quality result can thus be achieved by the continuous optimization of the model. The definition of the model by the optimization algorithm is thus based on a stepwise learning operation.

A further particularly preferred further development of the method can provide that the optimization algorithm analyzes the plurality of disturbance variables, the at least one control variable and/or the at least one target variable achieved thereby by means of a data analysis method and/or an image processing method, and the model adjusts the at least one control variable on the basis of an analysis result.

A self-learning model which independently defines, adapts and/or optimizes itself on the basis of analysis results can thus be achieved. By means of the optimization algorithm, a model based on machine learning, deep learning or artificial intelligence is thus formed. By means of the optimization algorithm, the model is able to perform an adjustment of the at least one control variable on the basis of all the determined disturbance variables, control variables and/or target variables, in order to achieve an optimization of at least one target variable. The definition of the model and optimization of the at least one target variable are carried out by the optimization algorithm in that the disturbance variables, control variables and/or target variables are continuously stored, are analyzed in dependence on one another, in particular the achieved target variables are analyzed in dependence on the determined and/or adjusted disturbance variables and/or control variables, and a decision on the adjustment of the at least one control variable is made on the basis of an analysis result. An analysis of the acquired data by such a data analysis method is also referred to as data analytics.

In an advantageous further development of the method, the at least one target variable for a workpiece to be coated can be determined in advance by means of the model.

An achievable quality result for a workpiece to be coated can thus be determined before the coating operation. In particular in the case of a change of one or a plurality of disturbance variables and/or control variables, for example the use of a different workpiece, coating material or adhesive, defective coating of workpieces can in this manner be avoided in advance and waste can be reduced.

The object is further achieved by a coating device for coating a workpiece, which preferably consists at least in part of wood, wood-based materials, plastics material or the like, with a coating material, in particular for coating a narrow side of the workpiece, having a feed device for feeding the coating material to the workpiece, a coating unit for applying the coating material to a surface of the workpiece, and having a control device for controlling the coating operation, wherein a method according to one of the above-described embodiments is controllable by the control device.

Preferably, the coating device can be configured to coat a narrow side of a workpiece in board form with a coating material. The coating device can have acquisition devices, measuring devices and/or sensors by means of which the plurality of disturbance variables, at least one control variable and/or at least one target variable can be acquired. In order to define the model for optimizing the at least one target variable, the plurality of disturbance variables, at least one control variable and/or at least one target variable can be transmitted to the control device of the coating device. The setting up and configuration of the coating device by a machine operator can thus largely be eliminated, so that a high degree of automation and a high quality result in the coating of workpieces can be achieved in this manner.

The object is additionally achieved by a computer program for setting up a coating device, in particular a coating device according to the above-described embodiment, which is stored in a control device of the coating device and by which a method according to one of the above-described embodiments is controllable.

There is thus formed a computer program by means of which the coating device can be set up on the basis of the model for optimizing the at least one target variable. On the basis of the optimization algorithm and by means of a large number of determined disturbance variables, control variables and/or target variables, the computer program is able to carry out a data analysis method, also referred to as data analytics, with the aim of continuously adapting and/or optimizing the at least one target variable. A self-learning model based on machine learning, deep learning or artificial intelligence can be achieved by the computer program, which model defines itself by means of the analysis results and dynamically adapts and/or optimizes itself with an increasing number of data sets (disturbance variables, control variables and/or target variables). A quality result of the coating operation by the coating device can thus be increased significantly by such a computer program.

### BRIEF DESCRIPTION OF THE DRAWINGS

Further features and advantages of a device, a use and/or a method will become apparent from the following description of embodiments with reference to the accompanying drawings, in which:

FIG. 1 shows a schematic illustration of a model of a method according to the disclosure for coating a workpiece;

FIG. 2 shows a schematic illustration of a coating device to illustrate the method according to FIG. 1.

### DESCRIPTION OF EMBODIMENTS

Identical reference numerals which are used in different figures denote identical, mutually corresponding or functionally similar elements.

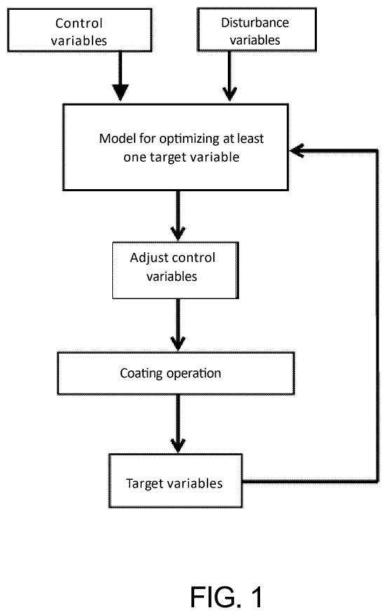

FIG. 1 shows a schematic illustration of a model of a method according to the disclosure for coating a workpiece 11 by a coating device 10.

Such a coating device 10 is configured to coat a surface of a workpiece 11 with a coating material 12 by means of an adhesive layer 13. In particular, the coating device 10 is provided for coating a narrow side 14 of the workpiece 11. A coating material 12 for coating the narrow side 14 is also referred to as edge material or an edge band.

In such a coating device 10, the workpiece 11 is coated in particular in a continuous process, in which the workpiece 11 is moved relative to the coating device 10.

The workpieces 11 to be processed are in particular workpieces which are formed at least in part of wood, wood-based materials, plastics material or the like. Preferably workpieces in board form, for example solid wood boards or particle boards, light building boards, composite boards or the like. However, the present invention is not limited to such workpieces 11 and materials.

By means of the model shown in the figures, it is ensured that a defined quality result of a coating operation by the coating device 10 is achieved. The quality result to be achieved can be quantified by means of at least one target parameter. Such a target parameter can be in particular a pull-off strength of the coating material 12 from the workpiece 11 after the coating operation, a tightness of the adhesive layer 13 between the coating material 12 and the workpiece 11, a layer thickness of the adhesive layer 13, a thermal stability of the adhesive layer 13, a shrink hole condition of the adhesive layer 13, a water vapor resistance of the adhesive layer 13 and/or of the coating material 12, and/or a resistance of the adhesive layer 13 and/or of the coating material 12 to immersion in water.

The target parameter can be acquired by corresponding acquisition devices 15 (measuring devices, sensors or the like).

In particular the pull-off strength of the coating material 12 from the workpiece 11 can be determined, for example, by at least partially destroying at least one workpiece 11 coated with the coating material 12. After the coating operation, the coating material 12 is detached from the workpiece 11 by corresponding means, and the pull-off force required therefor is determined. The required pull-off force, which is also referred to as the peel resistance, can be used as a measure of the coating quality.

In order to determine the thermal stability, the workpiece 11 coated with the coating material 12 is heated at a temperature of 50° C. for a defined time and the stability of the adhesive layer 13 and/or of the coating material 12 to heat is determined.

In order to determine the water vapor resistance, the workpiece 11 coated with the coating material 12 is exposed to water vapor for a defined time, and in order to determine the resistance to immersion in water, it is placed in a water bath for a defined time, and the stability of the adhesive layer 13 and/or of the coating material 12 to water vapor and/or water is determined.

The achievement of the at least one target variable is dependent on at least one control variable, by which the coating operation is at least partially controllable, and on a plurality of disturbance variables which influence the coating operation.

Each disturbance variable forms a defined parameter of the workpiece 11, of the coating material 12, of the adhesive 13, of an environment and/or of the coating device 10, for example of one or more processing tools of the coating device 10. The disturbance variable can form an unchangeable parameter.

The disturbance variables of the workpiece 11 can be physical and/or chemical properties of the workpiece 11, in particular of the surface and/or narrow side 14 to be coated. Such properties can be selected, by way of example and not exhaustively, from: the type of wood, the temperature of the workpiece 11, the temperature of a narrow side 14 of the workpiece 11, the material of the workpiece 11, the type of glue, processing additives, the proportions of recycled material, the condition of the surface (porosity, pore depth, volume of pores, shape of pores, type of chips, volume of chips) of the workpiece 11 and/or of the narrow side 14 of the workpiece 11, the moisture content of the workpiece 11, the nature of a milling cut on the surface and/or on the narrow side 14 of the workpiece 11 (straight cut, hollow cut or the like), the angle of the milling cut, the profile of the milling cut, the cut direction of the milling cut, the wettability of the workpiece 11 with the adhesive 13, the dimensions of the workpiece 11 (height, length, width).

The disturbance variables of the coating material 12, in particular edge material, can be physical and/or chemical properties of the coating material 12. Such properties can be selected, by way of example and not exhaustively, from: the material of the coating material 12, the type of coating material 12, the dimensions of the coating material 12 (height, width, length), the form of the coating material 12, the overlap of the coating material 12, a primer on a surface of the coating material 12.

The disturbance variables of the adhesive 13 can be physical and/or chemical properties of the adhesive 13. Such properties can be selected, by way of example and not exhaustively, from: the material composition of the adhesive 13, the proportions of separating agents, primers, plasticizers, additives, accelerators, retardants and the starting material (ABS, PP, PU, aluminum, wood, etc.) in the adhesive 13.

The disturbance variables of the environment can be selected, by way of example and not exhaustively, from: the ambient temperature, the ambient humidity, the ambient light intensity.

The disturbance variables of the coating device 10 can be selected, by way of example and not exhaustively, from: type of coating device 10, defined machine parameters, a degree of wear of one or more processing tools, the condition of the processing unit, the imbalance of the tool, or a combination thereof.

The disturbance variables can be acquired by corresponding acquisition devices 15 (measuring devices, sensors or the like) before, during and/or after the coating operation. Likewise, disturbance variables can be known, for example from manufacturer specifications, and stored in a control device 16 or retrievable by a control device 16.

Each control variable forms a changeable parameter of the workpiece 11, of the coating material 12, of the adhesive 13, of the environment and/or of the coating device 10.

The control variables of the workpiece 11 can be selected, by way of example and not exhaustively, from: the temperature (increase) of the workpiece 11, temperature (increase) of the narrow side 14, rate of feed V of the workpiece.

The control variables of the coating material 12 can be selected, by way of example and not exhaustively, from: coating material 12, temperature (increase) of the coating material 12, dimensions of the coating material 12 (width, height, length).

The control variables of the adhesive 13 can be selected, by way of example and not exhaustively, from: type of adhesive, amount of adhesive, temperature of the adhesive, application angle, layer thickness, wetting of the workpiece 11 and/or of an application device, in particular of an application roller 17, of an application brush or of a spray application device, temperature, speed and/or distance of the application device, surface condition of the application device, a contact temperature of the adhesive 13 with the application device.

If it is not possible to acquire the contact temperature of the adhesive 13, that is to say the temperature of the adhesive 13 at the contact point between the application device and the workpiece, by means of sensors, it can be calculated by an approximation algorithm. The contact temperature of the adhesive 13 is calculated in dependence on a distance between the contact point and a support point on the application device, in particular on the application roller 17, at which the temperature of the adhesive 13 is measured, the rate of advance of the workpiece 11, the temperature of the workpiece 11, in particular of the narrow side 14, the temperature of the coating material 12 and/or the heat capacity of the adhesive 13.

The control variables of the environment can be selected, by way of example and not exhaustively, from: the ambient temperature, the ambient humidity, the ambient light intensity.

The control variables of the coating device 10 can be selected, by way of example and not exhaustively, from: rate of feed V of the workpiece 11, rate of supply of the coating material 12, power of a heating unit, number of heating units, position of a melting unit, fill level of the melting unit, angle of an application unit 18, fill level of the application unit 18, opening of a metering unit, pressure of a trimming device and/or clamping device, pressing force of a pressing roller 19, number of pressing rollers 19, lift of the pressing rollers 19, contact temperature of the pressing rollers 19, angle of the pressing rollers 19, soiling of the pressing rollers 19, speed of the pressing rollers 19, position of a pressure zone of the pressing rollers 19.

As illustrated in FIG. 1 by means of the arrows, the model is defined on the basis of the disturbance variables, control variables and/or the target variables achieved thereby. The disturbance variables, control variables and/or target variables are acquired and inputted into the model in order, by adjusting one or more control variables, to optimize one or more target parameters that are to be achieved for a workpiece 11 to be coated.

In particular, adjustment of the control variables for optimizing the target variables that are to be achieved for a workpiece 11 to be coated is carried out by the model on the basis of disturbance variables, control variables and/or target variables of a large number of previously coated workpieces 11.

To that end, the disturbance variables, control variables and/or the target variables achieved thereby of the large number of coated workpieces 11 are stored in the model. By means of an optimization algorithm, the model is defined or adapted dynamically with regard to an optimized target variable on the basis of that data set of disturbance variables, control variables and/or target variables.

By means of the stored disturbance variables, control variables and/or target variables, the optimization algorithm performs a data analysis method, wherein at least one control variable is adjusted by the model on the basis of an analysis result in order to achieve an optimized target variable. To that end, the optimization algorithm performs a data analysis method referred to as data analytics.

In dependence on the scope of the data set, a successive learning operation is thus carried out by the optimization algorithm, whereby a dynamic definition of the model and thus continuous adaptation and/or optimization of the model in respect of a constant quality result is performed.

The data analysis method by the optimization algorithm can operate on the basis of descriptive analytics, diagnostic analytics and predictive analytics or on the basis of a combination thereof.

Within the scope of descriptive analytics, the optimization algorithm analyzes the determined disturbance variables, control variables and/or target variables in terms of the target variables of coated workpieces 11 that are achieved in dependence on the disturbance variables and/or control variables. In the data analysis method within the scope of descriptive analytics, the analysis is thus carried out on the basis of past and current data of coated workpieces 11 in order to identify from those data trends, patterns or results in respect of the achieved target variables, that is to say of the achieved quality result.

In the case of the data analysis method within the scope of diagnostic analytics, the analysis result of the descriptive analytics is evaluated in terms of the target variables that are achieved by corresponding disturbance variables and/or control variables.

By means of the data analysis method within the scope of predictive analytics, a statement is made on the basis of the analysis results from the descriptive analytics and/or diagnostic analytics as to which target variables are to be achieved in a workpiece to be coated in dependence on the disturbance variables and/or control variables and how the control variables must be correspondingly adjusted in order to achieve said target variables.

By means of this optimization algorithm, the model performs, in dependence on the scope of the stored disturbance variables, control variables and/or target variables, machine learning, deep learning or artificial intelligence in order to optimize at least one target variable for a workpiece to be coated on the basis of those data and to correspondingly adjust at least one control variable. In this manner, it can be determined by the model, also in advance, what target variables are achieved in dependence on acquired disturbance variables and/or control variables. The achievement of target variables in the case of the use of new workpieces 11, coating materials 12 and/or adhesives 13 can also be simulated in advance in this manner.

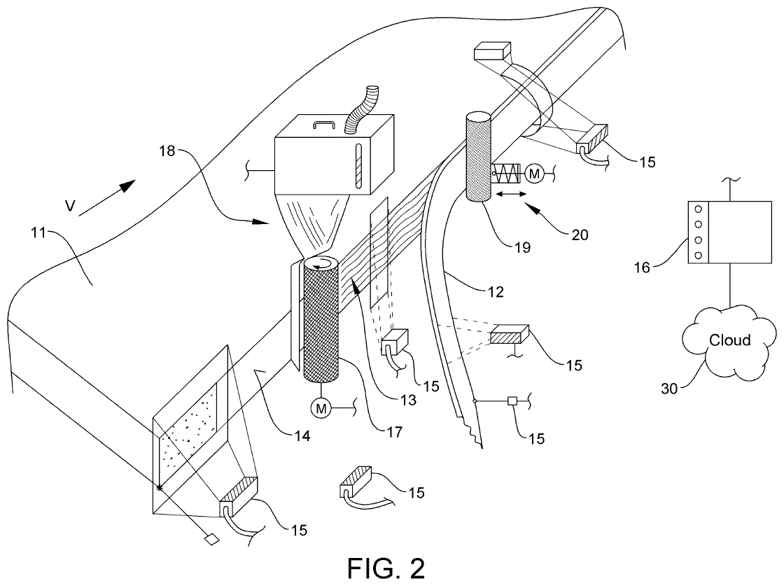

With reference to FIG. 2, the coating operation by the above-described method will now be described by way of example. FIG. 2 shows, schematically, the coating device 10, the workpiece 11 to be coated and the coating material 12 (edge material).

The coating device 10 comprises a plurality of individual components, described hereinbelow, which are connected to a control device 16 of the coating device 10. The control device 16 comprises a storage medium on which a computer program for setting up the coating device 10 or the individual components is stored, so that the method described according to FIG. 1 is controllable. The individual components of the coating device 10 are controllable by the control device 16 by means of the corresponding control variables.

The control device 16 is connected via a wired or wireless network to a server, for example via the intranet, internet or in the form of a network cloud 30. The control variables, disturbance variables and/or target variables as well as further data, for example manufacturer specifications relating to the workpieces 11, coating materials 12, adhesives 13 and the like which are used, can be stored in the control device 16 or on the server and retrievable by the control device 16.

Before the coating material 12 is adhered to the narrow side 14 of the workpiece 11, the above-described disturbance variables of the workpiece 11, coating material 12, adhesive 13, of the environment and/or of the coating device 10 are acquired by corresponding acquisition devices 15 and transmitted to the control device 16, in order to be inputted into the model for optimizing the at least one target parameter. As already described above, it is not necessary to acquire all the disturbance variables and/or control variables; rather, it is possible to acquire only the significant disturbance variables, on which there depend further disturbance variables, which can thus be validated.

Depending on the disturbance variables and/or control variables to be acquired, the acquisition devices 15 can be, for example, optical sensors, thermal sensors, terahertz measuring systems, optical coherence tomography, fluorescence measurement technology, photothermal measuring systems, triangulation or the like.

By means of the above-described optimization algorithm, the disturbance variables and/or control variables which have been acquired and inputted into the model are analyzed and, on the basis of the analysis result, the corresponding control variables are adjusted by the model, in order to correspondingly control the processing device 10, that is to say the application unit 18, pressing rollers 19, pressing device 20, feed device, heating unit, melting unit, trimming unit and the like, to carry out the coating operation, that is to say to achieve the at least one target variable (a desired value range of the target variable). Consequently, on the basis of the analysis result, processing parameters of the coating device 10 are adjusted, so that in particular a defined adhesive layer (quantity, temperature, time and the like) is applied to the narrow side 14 of the workpiece 11. Application of the adhesive 13 to the workpiece 11 is carried out by the application unit 18.

After application of the adhesive 13 to the narrow side 14 of the workpiece 11, the thickness of the adhesive layer actually applied to the workpiece 11 is acquired by the corresponding acquisition device 15 and is inputted into the model as a control variable. In this manner, monitoring of the adhesive application is provided, wherein the model adapts corresponding control variables on the basis of the acquired and inputted thickness of the adhesive layer, in order to maintain the application of the adhesive layer in a defined desired value range.

The coating material 12 is then fed to the workpiece 11 by a feed device (not shown), applied to the narrow side 14 of the workpiece 11 and adhered to the workpiece 11 by a pressing device 20 and the adhesive 13.

After the actual coating operation, the thickness of the adhesive layer as a target variable to be achieved is acquired a further time and is transmitted to the control device 16 and inputted into the model for the definition of the model and optimization of the control variables.

In addition, by the continuous acquisition and storage of the achieved target variables after the coating operation, digital documentation and evidence of the coating quality can be performed.

It is clear to the person skilled in the art that individual features which are each described in different embodiments can also be implemented in a single embodiment, provided that they are not structurally incompatible. Likewise, different features which are described within the scope of an individual embodiment can also be provided in a plurality of embodiments individually or in any suitable sub-combination.

1. A method for coating a workpiece (11), which preferably consists at least in part of wood, wood-based materials, plastics material or the like, wherein a coating material (12) is adhered to a surface of the workpiece (11) by means of an adhesive layer (13), having the steps:
defining a model for optimizing at least one target variable, in which the adjustment of at least one control variable in dependence on a plurality of disturbance variables is mapped,
determining a plurality of disturbance variables which influence the coating operation,
adjusting at least one control variable by means of the model and on the basis of the determined disturbance variables.

2. The method as claimed in claim 1, in which the at least one target variable is selected from a pull-off strength of the coating material (12) from the workpiece (11), a tightness of the adhesive layer (13) between the coating material (12) and the workpiece (11), a layer thickness of the adhesive layer (13), a thermal stability of the adhesive layer (13), a shrink hole condition of the adhesive layer (13), a water vapor resistance of the adhesive layer (13) and/or of the coating material (12), and/or a resistance of the adhesive layer (13) and/or of the coating material (12) to immersion in water.

3. The method as claimed in claim 1 or 2, in which the at least one target variable is determined by at least partially destroying at least one workpiece (11) coated with the coating material (12).

4. The method as claimed in claim 2 or 3, in which the results of the at least one selected target variable are used to define the model for optimizing at least one target variable.

5. The method as claimed in any one of the preceding claims, in which at least one disturbance variable is determined from at least one defined parameter of the workpiece (11), of the coating material (12), of the adhesive layer (13), of an environment and/or of a coating device (10), for example of at least one processing tool of the coating device (10).

6. The method as claimed in any one of the preceding claims, in which the at least one control variable is selected from at least one changeable parameter of the workpiece (11), of the coating material (12), of the adhesive layer (13), of the environment and/or of the coating device (10).

7. The method as claimed in any one of the preceding claims, in which the at least one control variable is monitored and used to define the model for optimizing at least one target variable, and is preferably selected from a pressing force of a pressing device (20), a contact temperature of the pressing device (20), a temperature, preferably contact temperature, of the adhesive on an application device, a temperature of the workpiece (11), coating material (12) and/or adhesive layer (13) prior to adhesion to the surface of a workpiece (11), and/or the layer thickness of the adhesive layer (13).

8. The method as claimed in any one of the preceding claims, in which the model is defined by means of the plurality of disturbance variables, the at least one control variable and/or the at least one target variable, achieved thereby, of at least one workpiece (11) coated by the coating operation, in order to optimize at least one target variable for at least one further workpiece (11) to be coated.

9. The method as claimed in claim 8, in which the model is defined dynamically by an optimization algorithm by means of the plurality of disturbance variables, the at least one control variable and/or the at least one target variable achieved thereby of a large number of workpieces (11) coated by the coating operation.

10. The method as claimed in claim 9, in which the optimization algorithm analyzes the plurality of disturbance variables, the at least one control variable and/or the at least one target variable achieved thereby by means of a data analysis method and/or an image processing method, and the model adjusts the at least one control variable on the basis of an analysis result.

11. The method as claimed in any one of the preceding claims, in which the at least one target variable for a workpiece (11) to be coated is determined in advance by means of the model.

12. A coating device (10) for coating a workpiece (11), which preferably consists at least in part of wood, wood-based materials, plastics material or the like, with a coating material (12), in particular for coating a narrow side (14) of the workpiece (11), having a feed device for feeding the coating material (12) to the workpiece (11), a coating unit for applying the coating material (12) to a surface of the workpiece (11), and having a control device (16) for controlling the coating operation, wherein a method as claimed in any one of claims 1 to 11 is controllable by the control device (16).

13. A computer program for setting up a coating device (10), in particular a coating device (10) as claimed in claim 12, which is stored in a control device (16) of the coating device (10) and by which a method as claimed in any one of claims 1 to 11 is controllable.
